(19) United States
(12) Patent Application Publication
(10) Pub. No.: US 2020/0164715 A1
(43) Pub. Date: May 28, 2020

(54) POROUS AIR INLET DUCT FOR A HVAC SYSTEM

(71) Applicant: Valeo Systemes Thermiques, Le Mesnil Saint Denis Cedex (FR)

(72) Inventors: Julien Brault, Le Mesnil Saint Denis (FR); Cédric Van Schammelhout, Le Mesnil Saint Denis (FR)

(73) Assignee: Valeo Systemes Thermiques, Le Mesnil Saint Denis Cedex (FR)

(21) Appl. No.: 16/611,077

(22) PCT Filed: Apr. 19, 2018
(86) PCT No.: PCT/FR2018/050985

§ 371 Date: Nov. 5, 2019

(30) Foreign Application Priority Data
May 5, 2017 (FR) 1753982

(51) Int. Cl. B60H 1/00

(52) U.S. Cl. CPC B60H 1/00514; B60H 2001/006; B60H 1/00564

(57) ABSTRACT

The invention relates to an apparatus (1) for thermally conditioning an air flow for a motor vehicle, comprising at least one heat exchanger, an air blower (4) adapted for blowing a pressurised air flow to said exchanger, a conditioning housing (5) adapted for directing the pressurised air from said blower (4) to said heat exchanger, and at least one outlet for distributing the conditioned air in the passenger compartment of said vehicle, said apparatus (1) being characterised in that it comprises at least one wall (8) formed from a porous material.

### 1. FIELD

The present invention relates to a heating, ventilation and air conditioning system for a passenger compartment of a motor vehicle, often known as “HVAC” (“Heating, Ventilation and Air Conditioning”) and referred to below as “thermal conditioning apparatus”.

### 2. PRIOR ART

By capturing the external air to distribute it within the passenger compartment, the thermal conditioning systems of a vehicle play a decisive role in the heating, air-conditioning and demisting of the windows. These systems are relatively large in size and are designed to be installed in the engine compartment of the vehicle below the dashboard.

As FIGS. 1 and 2 show, a thermal conditioning apparatus 1 typically comprises an air intake unit 2 with an external air inlet 2b which is intended to draw in air from outside the vehicle, and an internal air inlet 2a which is intended to recondition the air taken from the passenger compartment of the vehicle.

Since the air of the passenger compartment is generally already at optimal comfort temperature, such a recycling of the internal air therefore allows a reduction in the energy consumption of the thermal conditioning apparatus 1. The two air inlets 2a and 2b may each be closed and opened selectively by a separate air flap.

The external air inlet 2b may alternatively be oriented towards the underfloor area of the vehicle or towards the lower part of the windscreen. In the second case, it is typically connected to an air filter and a separator, the function of which is to separate rain-water from the air taken from the outside below the windscreen.

The two air inlets 2a and 2b are connected via an intake pipe 3 to an upper wall of a spiral scroll casing 4a containing an air blower 4 driven around a central shaft.

The upper wall of the spiral scroll casing 4a is substantially flat and in its center comprises an axial intake opening intended to communicate with the intake pipe 3. The scroll casing 4a is essentially coaxial to the axis of the blower 4, although the lower end of its side wall forms a spiral of increasing radius which is intended to progressively orient the air flow towards a tangential outlet opening.

The air flow pressurized by the blower 4 is then conducted via a conditioning unit 5 towards a radiator intended to heat the air flow before it is distributed into the passenger compartment via distribution outlets 6.

In the known fashion, a thermal conditioning apparatus may be either centered or semi-centered, depending on whether the blower 4 is integrated within the thermal conditioning apparatus or is offset on one of its side faces.

The distribution outlets 6 generally comprise at least one defrosting/demisting vent for the windscreen, at least one defrosting/demisting vent for the side windows, at least one air vent mounted on the dashboard, and at least one vent opening towards the lower part of the passenger compartment.

In the case where the thermal conditioning apparatus is equipped with an air conditioning option, it comprises an evaporator, the function of which is to cool and dehumidify the air flow. Advantageously, the evaporator is placed upstream of the radiator, which allows the air to be cooled if desired in order to be dehumidified before it is reheated.

A thermal conditioning apparatus 1 according to the prior art has several disadvantages. When the thermal conditioning apparatus 1 is in operation, it generates considerable noise because of both the movement of the air flow in the ducts and also the activity of the blower. This noise may spread into the passenger compartment via the distribution outlets of the apparatus. It then constitutes a significant noise nuisance for the occupants of the passenger compartment.

In order to remedy this problem, the solutions of the prior art comprise increasing the thickness of the inner walls of the air conditioning system so that the latter can absorb some of the sound emissions before they reach the distribution outlets.

These solutions however have the critical drawback of requiring a significant increase in the mass of the thermal conditioning apparatus, and hence an increase in the energy consumption of the vehicle to which it is fitted.

In this context, the present invention aims to provide an improved thermal conditioning apparatus which rectifies some of the above-mentioned drawbacks while being lightweight, compact and easy to assemble.

### 3. SUMMARY

The proposed system meets this need. More particularly, in at least one embodiment, the proposed system relates to an apparatus for thermally conditioning an air flow for a motor vehicle, comprising at least one heat exchanger, an air blower designed for blowing a pressurized air flow towards said exchanger, a conditioning housing designed for directing the pressurized air from said blower towards said heat exchanger, and at least one outlet for distributing the conditioned air in the passenger compartment of said vehicle, said apparatus being characterized in that it comprises at least one wall formed from a porous material.

In the present description, the phrase “apparatus for thermally conditioning an air flow for a motor vehicle” designates an apparatus for heating, ventilation and/or air conditioning for a passenger compartment of a motor vehicle, also known as a HVAC system (heating, ventilation and air conditioning). Also, a “wall” in the sense of the invention delimits a duct such as an air intake duct, or a housing containing the moving air flow driven by the blower. A heat exchanger may take the form of a radiator, the function of which is to heat the air passing through it, or an evaporator, the function of which is to cool and dehumidify the air flow.

A thermal conditioning apparatus according to the invention comprises at least one wall made of a porous material, i.e. with a structure characterized by the presence of a plurality of open and/or closed pores.

Such a porous material has several advantageous characteristics. Firstly, because of its porous nature and mechanical flexibility, it forms good sound insulation. It is therefore able to limit the spread of sound waves in the ducts of the thermal conditioning apparatus. The reduction in noise applies not only to high frequencies but also to the low frequencies generated by the structure of the system.

Such a porous material is furthermore characterized by a lower volumetric mass of the order of 15%. For equal volume, an apparatus for thermally conditioning an air flow according to the invention offers better noise reduction, lower mass and greater flexibility.

According to a particular aspect of the invention, the porosity of said porous material is greater than 0.8.

The porosity is the ratio between the volume of the pores and the total volume of a porous medium. A porosity of more than 0.8 represents a favorable condition for obtaining a porous wall offering better noise reduction, lower mass and greater flexibility.

According to a particular aspect of the invention, the diameter of the pores is between 10 and 100 μm.

Such a pore diameter represents a favorable condition for obtaining a porous wall offering better noise reduction, lower mass and greater flexibility.

According to a particular aspect of the invention, said wall has at least two zones of different porosity.

As described above, the noise attenuation by the wall and its flexibility increase with the degree of porosity, and vice versa. However, its mass increases when the porosity diminishes. In the context of a wall with at least two zones of different porosity, or in other words several degrees of porosity, the choice of location of the most porous zone therefore allows adjustment of the wall properties zone by zone as a function of the needs and technical constraints to be observed, in particular in terms of mechanical strength.

According to a particular aspect of the invention, said porous material is air-permeable.

In other words, this porous material comprises an open porous structure in which the pores are interconnected and form very fine channels for passage of the air.

According to a particular aspect of the invention, the thermal conditioning apparatus is designed to attenuate sound waves with a frequency between 20 Hz and 20 kHz.

Several parameters are considered in order to vary the range of sound wave attenuation, such as:
the tortuosity, which designates the ratio between the distribution of air in a free space and the distribution of air through the porous material,
the resistance to air flow,
the dimension of the pores and the links existing between the pores,
the elastic parameters of the porous material, including Young's modulus and Poisson's ratio.

A thermal conditioning apparatus according to the invention thus allows an improvement in the acoustic comfort in the passenger compartment of the vehicle by reducing the noise generated within the HVAC system.

According to a particular aspect of the invention, said porous material is polypropylene.

Polypropylene has the advantage of being lightweight while having satisfactory mechanical strength with respect to its usage. It is also suitable for production processes which are relatively simple to implement, such as over-molding.

According to a particular aspect of the invention, said wall comprises at least one stiffening rib.

This allows mechanical reinforcement of said porous wall while limiting the increase in its mass.

According to a particular aspect of the invention, said wall is located upstream of and/or level with said blower in the flow direction of said air flow.

When the air blower is running, it draws an air flow from the outside and/or from the inside of the vehicle via the air intake duct, thus creating a reduced pressure in the interior of the latter. The air-permeable porous surface of an intake duct according to the invention allows the passage of air between the interior and exterior of the duct. When the interior has a reduced pressure, an air flow from the outside of the duct—and in particular from the passenger compartment of the vehicle—may be drawn through said porous wall towards the interior of the duct and then into the blower. Such a duct may therefore capture an air flow from the interior of the vehicle without using a dedicated intake opening, this opening being the source of load losses and significant noise.

According to a particular aspect of the invention, said at least one wall is located downstream of said blower in the flow direction of said air flow.

Advantageously, said wall is located level with the non-functional surfaces of the thermal conditioning apparatus, for example said conditioning housing forming the link between the blower and the radiator and/or evaporator, the evacuation zone for the water condensed by the evaporator, the rear sprinkler plate, or the distribution outlets.

According to a particular aspect of the invention, said wall is covered by an air-impermeable film on its outer face.

When the air blower is running, it blows the pressurized air flow towards the parts arranged downstream thereof, thus creating a positive pressure in the ducts and housing concerned. Because of the porous nature of the walls according to the invention, the air flowing inside the duct is at least partially diffused through this porous wall towards the outside of the thermal conditioning apparatus, thus causing leaks. The addition of an air-impermeable film on the outer face of the wall blocks this diffusion process and thus limits the corresponding leaks.

According to a particular aspect of the invention, said wall is covered by a water-impermeable film on its inner face.

At the evacuation zone of the water condensed by the evaporator, also called the condensation tray, the collected water may be absorbed by the porous wall, making it difficult to evacuate this water while reducing the capacity of the porous wall to attenuate noise. By covering this wall with a water-impermeable film on its inner face, this drawback may be remedied since the water-impermeable film prevents the water from coming into contact with the porous wall.

According to a particular aspect of the invention, said wall is a multilayer wall formed by the superposition of an inner layer of porous material, an air-impermeable film, and an outer layer of porous material.

Such a multilayer structure allows noise to be attenuated both inside and outside the thermal conditioning apparatus while limiting the load losses associated with the diffusion of an air flow under positive pressure from the interior towards the outside of the thermal conditioning apparatus.

The invention also concerns a motor vehicle characterized in that it comprises a thermal conditioning apparatus as described above.

The invention also concerns the use of a porous material for production of a wall of an apparatus for thermally conditioning an air flow for a motor vehicle.

The invention also concerns a method for production of a wall of porous material for an apparatus for thermally conditioning an air flow for a motor vehicle, said method comprising a step of thermoforming said wall.

According to a particular aspect, said thermoforming step is implemented with different compression levels.

It is thus possible to obtain a porous wall with variations in thickness and/or porosity.

### 4. FIGURES

Further characteristics and advantages of the invention will appear from reading the following description of particular embodiments, given merely as illustrative and non-limitative examples, and the attached figures in which:

FIG. 1 shows a front view of a thermal conditioning apparatus for a passenger compartment of a vehicle according to the prior art,

FIG. 2 shows a rear view of the apparatus from FIG. 1,

FIGS. 3a to 3d show diagrammatic views of a conditioning housing of a thermal conditioning apparatus according to one embodiment of the invention,

FIG. 4 shows a diagrammatic representation from the side of an air intake unit of a thermal conditioning apparatus according to one embodiment of the invention,

FIGS. 5a and 5b show diagrammatic representations of the lower and upper parts of the condensation tray of a thermal conditioning apparatus according to one embodiment of the invention,

FIGS. 6a and 6b show diagrammatic representations of the left side part, viewed from the front, of the distributor of a thermal conditioning apparatus according to one embodiment of the invention,

FIG. 7 shows a diagrammatic representation of the right side part of the distributor of a thermal conditioning apparatus according to one embodiment of the invention,

FIG. 8 shows a diagrammatic representation of the central part of the distributor of the thermal conditioning apparatus according to one embodiment of the invention,

FIG. 9 shows a cover of a thermal conditioning apparatus according to one embodiment of the invention,

FIGS. 10a and 10b show the passenger compartment air distribution duct of a thermal conditioning apparatus according to one embodiment of the invention.

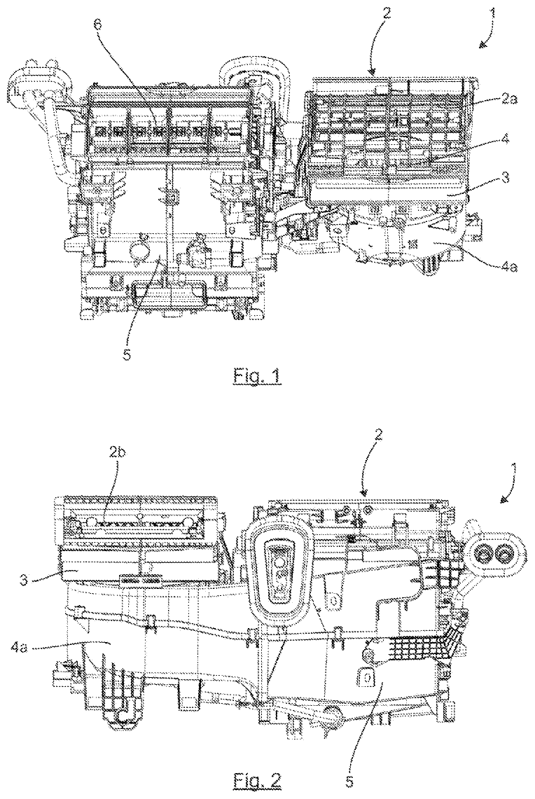

The various elements illustrated by the figures are not necessarily shown in true scale, the priority rather being given to depicting the general function of the invention.

### 5. DETAILED DESCRIPTION OF PARTICULAR EMBODIMENTS OF THE INVENTION

Several particular embodiments of the invention are described below. It is of course understood that the present invention is in no way limited by these particular embodiments, and other embodiments may be implemented.

The principle of the invention is to provide an apparatus for thermally conditioning an air flow, which apparatus, for the same volume, offers better noise reduction, lower mass and greater flexibility.

Such an apparatus 1 also comprises at least one wall 8 made of a porous material.

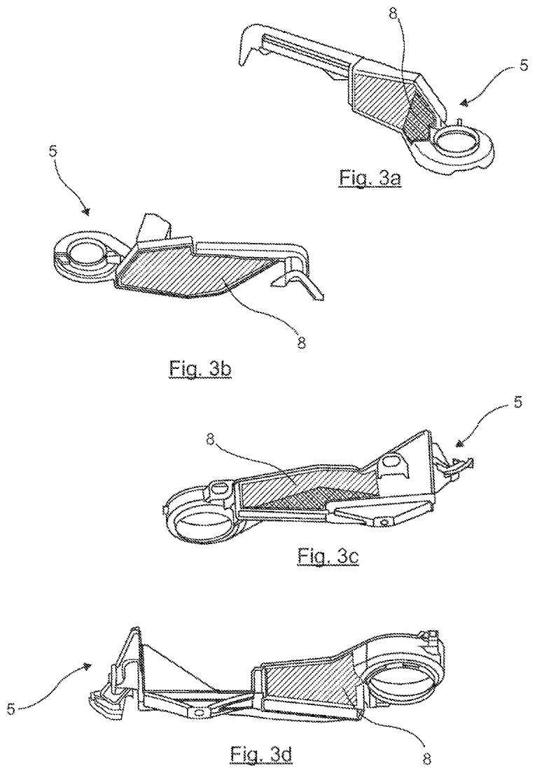

FIGS. 3a to 3d are diagrammatic views of a conditioning housing 5 of a thermal conditioning apparatus 1 according to the invention. Such a housing 5 is located downstream of the blower 4 in the air flow direction.

As illustrated on FIG. 3a, the conditioning housing 5 comprises a porous wall 8 of surface area equal to 1.4 dm² and a thickness of 20 mm. This wall 8 is made of an air-permeable porous material, i.e. with an open porous structure in which the pores are interconnected and form very fine channels for the passage of air.

According to a particular aspect of the invention, the porosity of said porous material is greater than 0.8 and the diameter of the pores is between 10 and 100 μm.

Such a wall 8 is intended in particular to attenuate sound waves with a frequency of between 20 Hz and 20 kHz, which allows an improvement in the acoustic comfort in the passenger compartment of the vehicle by reducing the noise generated within the HVAC system 1.

This wall 8 is covered with an air-impermeable film (not shown) on its outer face.

When the air blower 4 is running, it blows the pressurized air flow towards the parts arranged downstream thereof, thus creating a positive pressure in the ducts and housing concerned, including the conditioning housing 5. Because of the porous nature of the walls 8, the air flowing inside the duct is diffused at least partly through these porous walls 8 towards the outside of the thermal conditioning apparatus 1, causing leaks. The addition of the air-impermeable film on the outer face of the wall 8 allows this diffusion process to be blocked, thus limiting the risks of leakage.

FIGS. 3b to 3d illustrate different parts of the conditioning housing 5, each comprising a porous wall 8 of 20 mm thickness, the surface areas of which are equal respectively to 4, 3 and 1.4 dm².

FIG. 4 is a side view of the air intake unit 2 of a thermal conditioning apparatus 1 having an air-permeable porous wall 8. Such an air intake unit 2 is located upstream of the blower 4 in the air flow direction.

When the air blower 4 is running, it draws an air flow from the outside and/or inside of the vehicle via this air intake duct 2, thus causing a reduced pressure therein. The permeable porous surface 8 of the intake duct 2 allows air to pass between the interior and exterior of the duct 2. When the interior thereof is under reduced pressure, an air flow from the outside of the duct 2, and in particular from the passenger compartment of the vehicle, may be drawn through this porous wall 8 into the interior of the duct 2 and then into the blower 4. Such a duct 4 therefore allows an air flow to be drawn from the interior of the vehicle without a dedicated intake opening being required, this opening being a source of load losses and considerable noise.

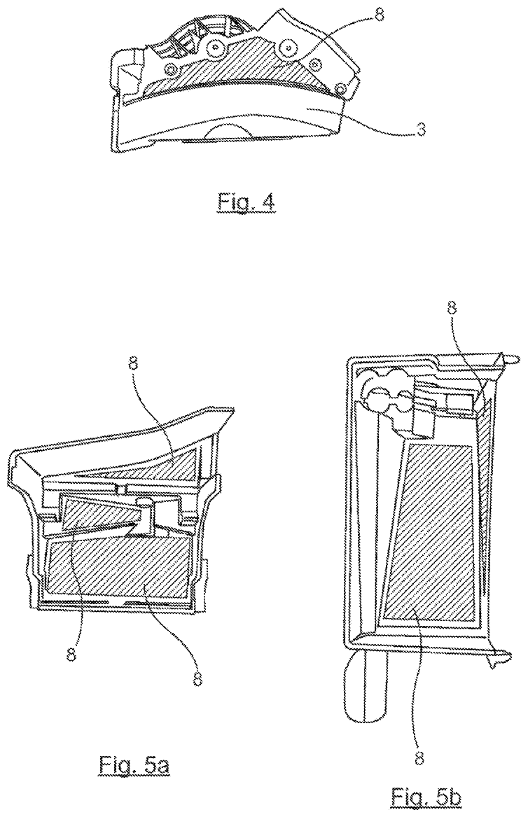

FIGS. 5a and 5b are diagrammatic views of the lower and upper parts of the condensation tray of a thermal conditioning apparatus having several porous walls 8, in particular porous walls 8 of surface areas equal to 1.3 and 0.4 dm². Such a condensation tray is located downstream of the blower 4 in the air flow direction, and its function is in particular to collect the condensed water vapor from the evaporator.

A base wall 8 of this condensation tray is covered with a water-impermeable film (not shown) on its inner face. This film prevents the water from coming into contact with the porous wall 8, thus avoiding the absorption of water by the porous wall 8. The use of this film therefore allows this porous wall 8 to retain its capacity to attenuate noise while facilitating evacuation of the water collected in the tray.

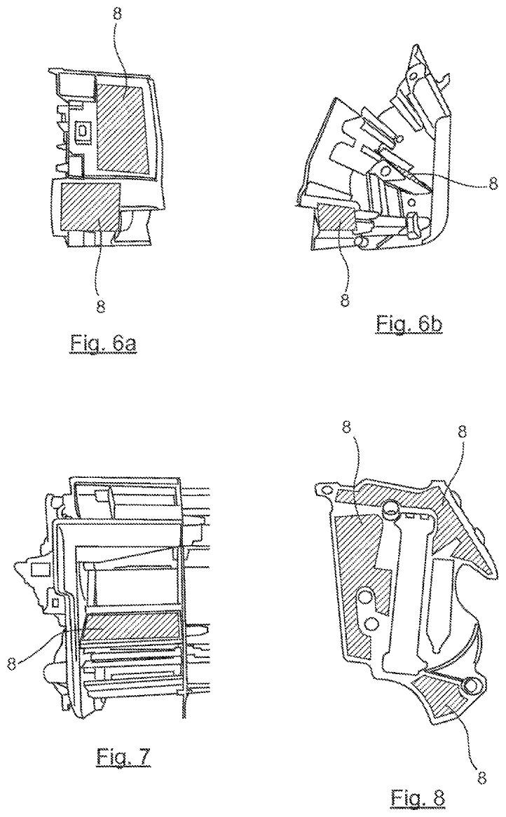

FIGS. 6a and 6b are respectively a view of the left side part and a front view of the distributor of the thermal conditioning apparatus 1 which has several porous walls 8, including one wall 8 of surface area equal to 1 dm² and thickness equal to 10 mm, and one wall 8 of surface area equal to 0.4 dm² and thickness equal to 2 mm. Each of these walls 8 has a water-impermeable film (not shown) on its inner face.

FIGS. 7 to 10b illustrate other parts of the thermal conditioning apparatus 1 located downstream of the blower 4, and each comprising one or more porous walls 8.

In particular, FIG. 7 is a diagrammatic view of the right side part of the distributor of a thermal conditioning apparatus 1.

FIG. 8 is a view of the central part of the distributor of a thermal conditioning apparatus 1 having several porous walls 8, including one porous wall 8 of surface area equal to 1 dm² and thickness equal to 2 mm.

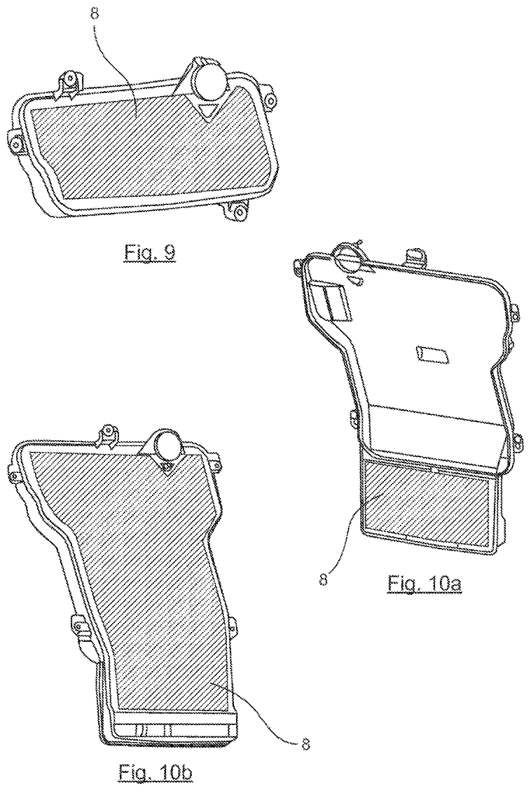

FIG. 9 is a diagrammatic view of the cover of a thermal conditioning apparatus 1 which comprises a porous wall 8 of surface area equal to 1.5 dm².

FIGS. 10a and 10b illustrate ducts for distributing the air in the passenger compartment, each comprising a porous wall 8 of surface area respectively equal to 0.7 and 2.9 dm².

1. An apparatus for thermally conditioning an air flow for a motor vehicle, comprising:
at least one heat exchanger;
an air blower for blowing a pressurized air flow towards said exchanger;
a conditioning housing for directing the pressurized air from said blower towards said heat exchanger;
at least one outlet for distributing the conditioned air in the passenger compartment of said vehicle; and
at least one wall formed from a porous material.

2. The thermal conditioning apparatus as claimed in claim 1, wherein the porosity of said porous material is greater than 0.8.

3. The thermal conditioning apparatus as claimed in claim 1, wherein said porous material is air-permeable.

4. The thermal conditioning apparatus as claimed in claim 1, wherein the apparatus is configured to attenuate sound waves with a frequency between 20 Hz and 20 kHz.

5. The thermal conditioning apparatus as claimed in claim 1, wherein said wall comprises at least one stiffening rib.

6. The thermal conditioning apparatus as claimed in claim 3, wherein said wall is located upstream of and/or level with said blower in the flow direction of said air flow.

7. The thermal conditioning apparatus as claimed in claim 1, wherein said at least one wall is located downstream of said blower in the flow direction of said air flow.

8. The thermal conditioning apparatus as claimed in claim 7, wherein said wall is covered by an air-impermeable film on an outer face.

9. The thermal conditioning apparatus as claimed in claim 7, wherein said wall is covered by a water-impermeable film on an inner face.

10. The thermal conditioning apparatus as claimed in claim 1, wherein said wall is a multilayer wall formed by the superposition of an inner layer of porous material, an air-impermeable film, and an outer layer of porous material.

11. An apparatus for heating, ventilation and/or air conditioning (HVAC) for a passenger compartment of a motor vehicle, comprising:
at least one heat exchanger;
an air blower for blowing a pressurized air flow towards said exchanger;
a conditioning housing for directing the pressurized air from said blower towards said heat exchanger;
at least one outlet for distributing the conditioned air in the passenger compartment of said vehicle; and
at least one wall delimiting an air intake duct, the wall being formed of a porous material having a plurality of open and/or closed pores,
said wall having at least two zones of different porosity.

12. The apparatus of claim 11, wherein the wall is produced by thermoforming the wall using different compression levels to form the at least two zones of different porosity and varying levels of thickness of the wall.

13. An apparatus for heating, ventilation and/or air conditioning (HVAC) for a passenger compartment of a motor vehicle, comprising:
at least one heat exchanger;
an air blower for blowing a pressurized air flow towards said exchanger;
a conditioning housing for directing the pressurized air from said blower towards said heat exchanger;
at least one outlet for distributing the conditioned air in the passenger compartment of said vehicle; and
at least one wall delimiting an air intake duct, the wall being formed of a porous material having an open porous structure in which pores are interconnected to form fine channels for passage of the pressurized air.
